(19) United States
(12) Patent Application Publication
(10) Pub. No.: US 2011/0261285 A1
(43) Pub. Date: Oct. 27, 2011

(54) ELECTRONIC DEVICE HAVING A LIQUID CRYSTAL DISPLAY MODULE

(75) Inventor: Shao-Ping Wang, Zhongshan City (CN)

(73) Assignees: HON HAI PRECISION INDUSTRY CO., LTD., Tu-Cheng (TW); AMBIT MICROSYSTEMS (ZHONGSHAN) LTD., Zhongshan City (CN)

(21) Appl. No.: 12/862,763

(22) Filed: Aug. 25, 2010

(30) Foreign Application Priority Data
Apr. 21, 2010 (CN) 201020165546.X

(51) Int. Cl. G02F 1/1333

(52) U.S. Cl. 349/60

(57) ABSTRACT

An electronic device includes a bezel, a housing, a liquid crystal display (LCD) module, a shielding frame and a rubber frame. The housing includes a frame portion defining a plurality of latching grooves and a plurality of receiving grooves and a supporting shoulder. The LCD module is received in the housing and supported on the supporting shoulder. The rubber frame is disposed between the housing and the LCD module. The shielding frame including a plurality of latching portions covers the rubber frame. The latching portions engage with the plurality of latching grooves to fix the LCD module in the housing. The bezel includes a panel covering the shielding frame and a plurality of retaining arms respectively received in the plurality of receiving grooves and engaged with the shielding frame to secure the bezel to the shielding frame.

### BACKGROUND

1. Technical Field

The present disclosure generally relates to electronic devices, and more particularly to an electronic device having a liquid crystal display (LCD) module.

2. Description of Related Art

FIGS. 6-7 illustrate a prior electronic device 200. The electronic device 200 comprises a bezel 202, a housing 204, a LCD module 206, a rubber frame 207 and a shielding frame 208. The LCD module 206 is surrounded by the rubber frame 207. The shielding frame 208 covers the rubber frame 207 to improve capability of the LCD module to resist pressure. The bezel 202 comprises a plurality of hooks 2022, and the housing 204 comprises a plurality of latching block 2042 correspondingly to engage with the corresponding hooks 2022 to secure the bezel 202 to the housing 204. The LCD module 206 surrounded by the rubber frame 207 and the shielding frame 208 is received in the housing 204. The bezel 202 covers the shielding frame 208 and is fixed to the housing 204 via engagement of the hooks 2022 with the latching blocks 2042, thereby securing the LCD module 206 in the housing 204.

In the prior electronic device 200, the hooks 2022 of the bezel 202 must be fabricated with enough rigidity and thickness to assure the stability of the LCD module 20, which unavoidably increases the size of the electronic device 200.

Therefore, a need exists in the industry to overcome the described limitations and reduce the size of the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a perspective view of an electronic device of an exemplary embodiment of the disclosure.

FIG. 2 is an exploded, perspective view of FIG. 1.

FIG. 3 is another enlarged, perspective view of FIG. 1.

FIG. 4 is a cross-section along line IV-IV of FIG. 1.

FIG. 5 is a cross-section along line V-V of FIG. 1.

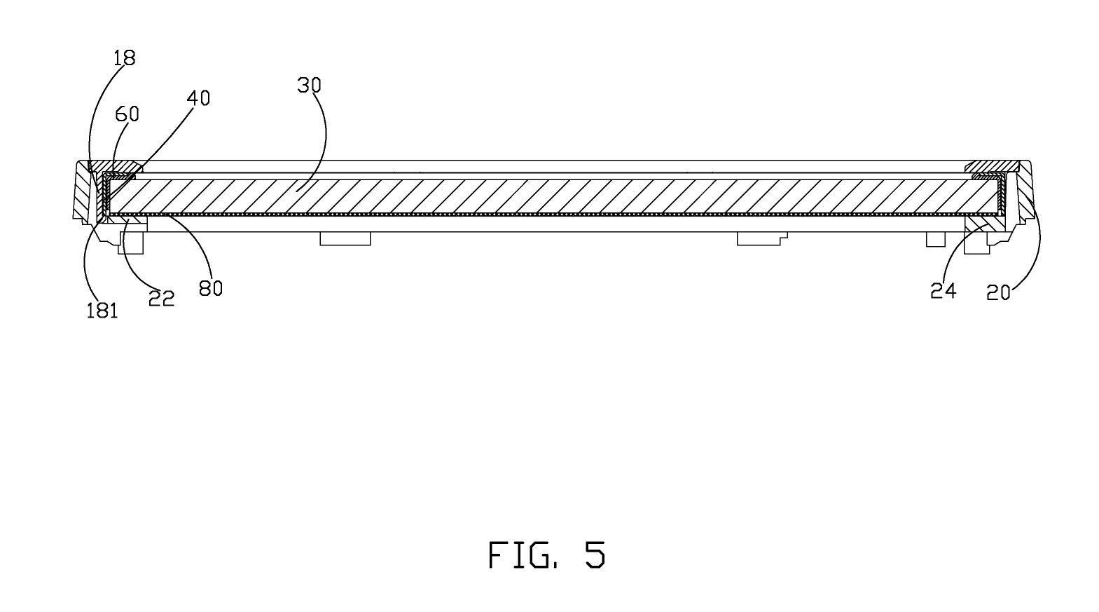

FIG. 6 is an exploded, perspective view of an electronic device in prior art.

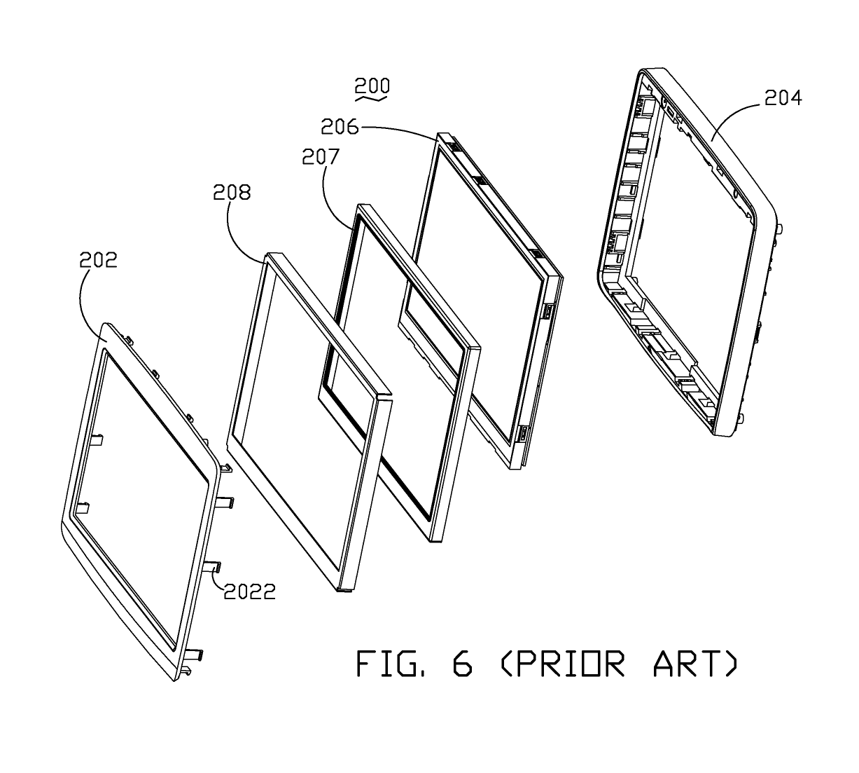

FIG. 7 is a cross-section view of FIG. 6.

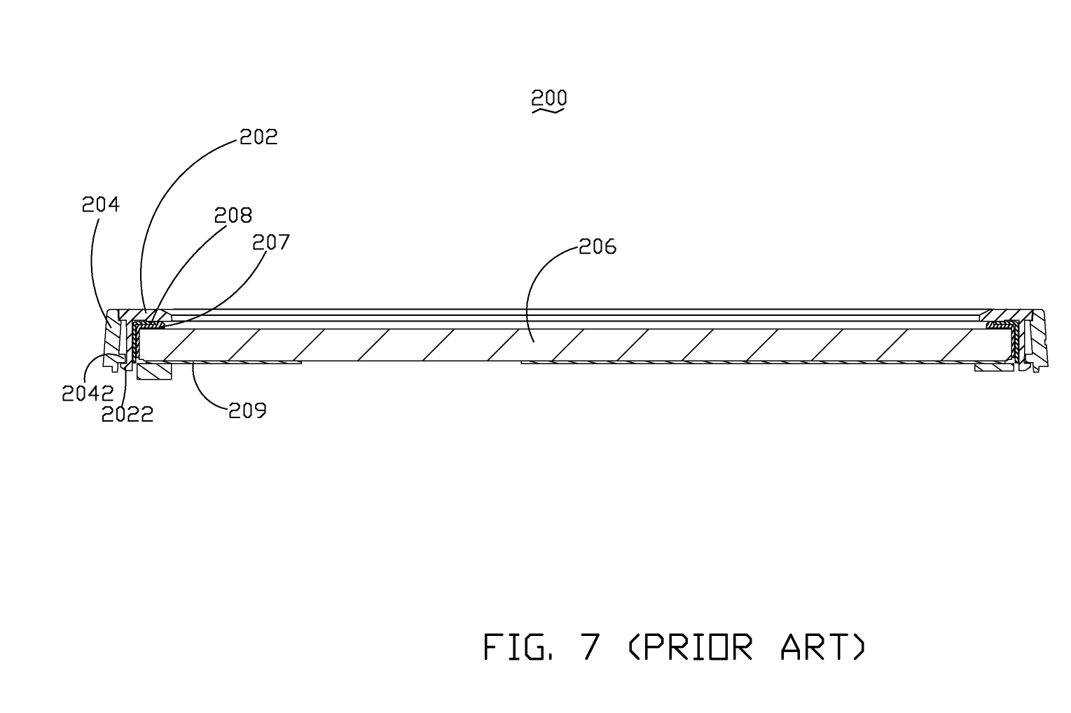

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

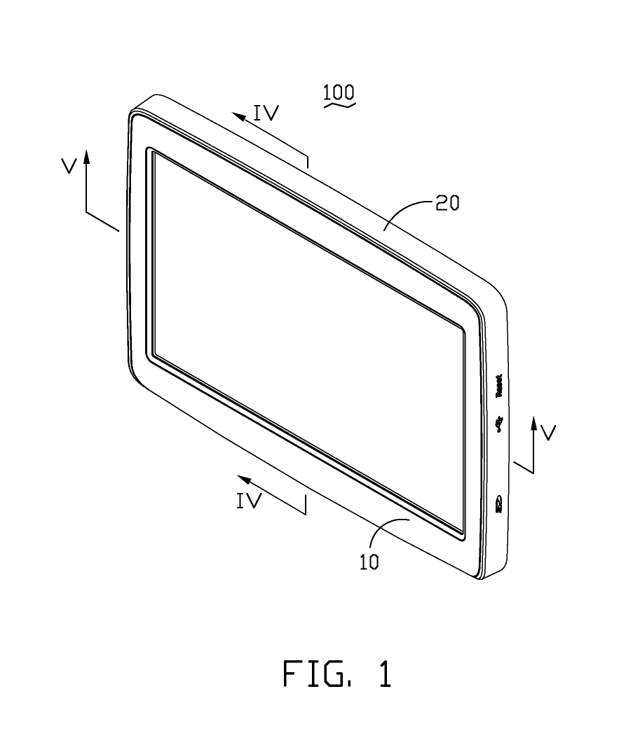

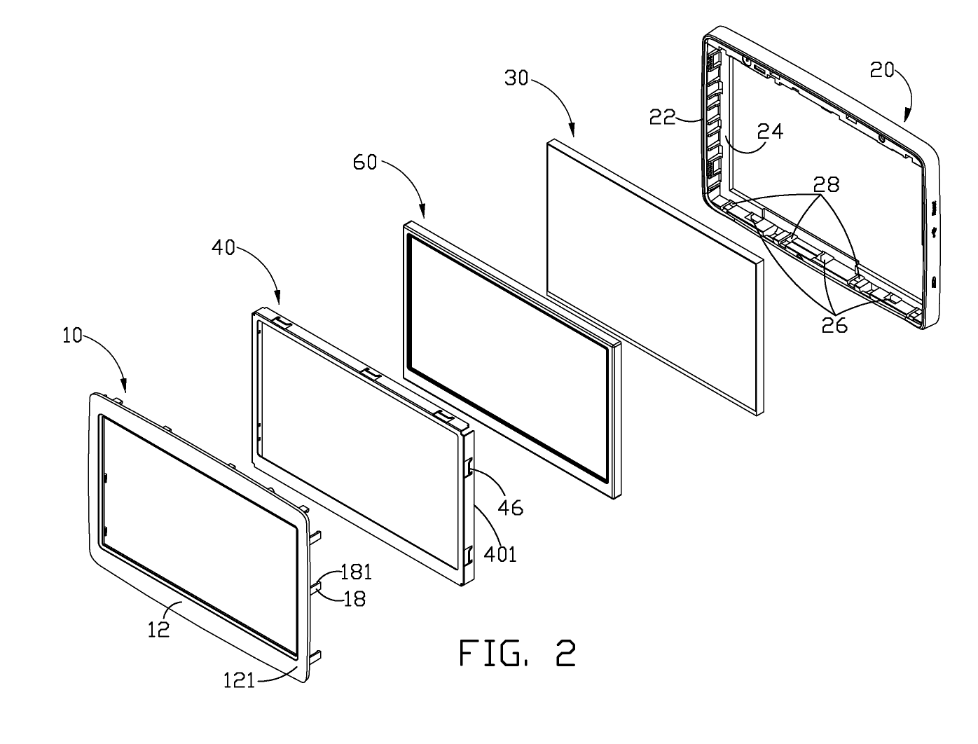

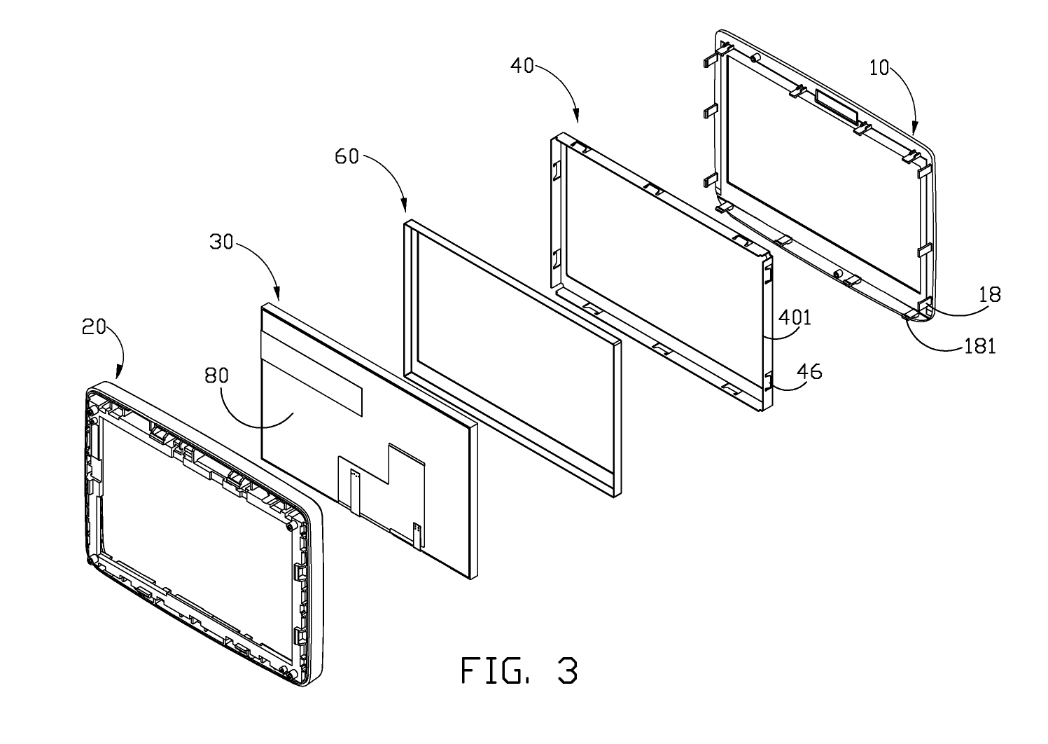

Referring to FIGS. 1-3, an exemplary electronic device 100 comprises a bezel 10, a housing 20, a LCD module 30, a shielding frame 40 and a rubber frame 60. In an exemplary embodiment, the electronic device 100 may be a mobile phone, a personal digital assistant (PDA), or a digital information appliance, for example, but the disclosure is not limited thereto. The housing 20 comprises a frame portion 22 and a supporting shoulder 24 extending inwardly from the frame portion 22. The frame portion 22 defines a plurality of latching grooves 26 and a plurality of receiving grooves 28.

The LCD module 30 is received in the housing 20 and supported on the supporting shoulder 24. The rubber frame 60 is disposed between the housing 20 and the LCD module 30 to protect the LCD module 30 from shocks and vibrations. In the embodiment, the rubber frame 60 covers the edge of LCD module 30.

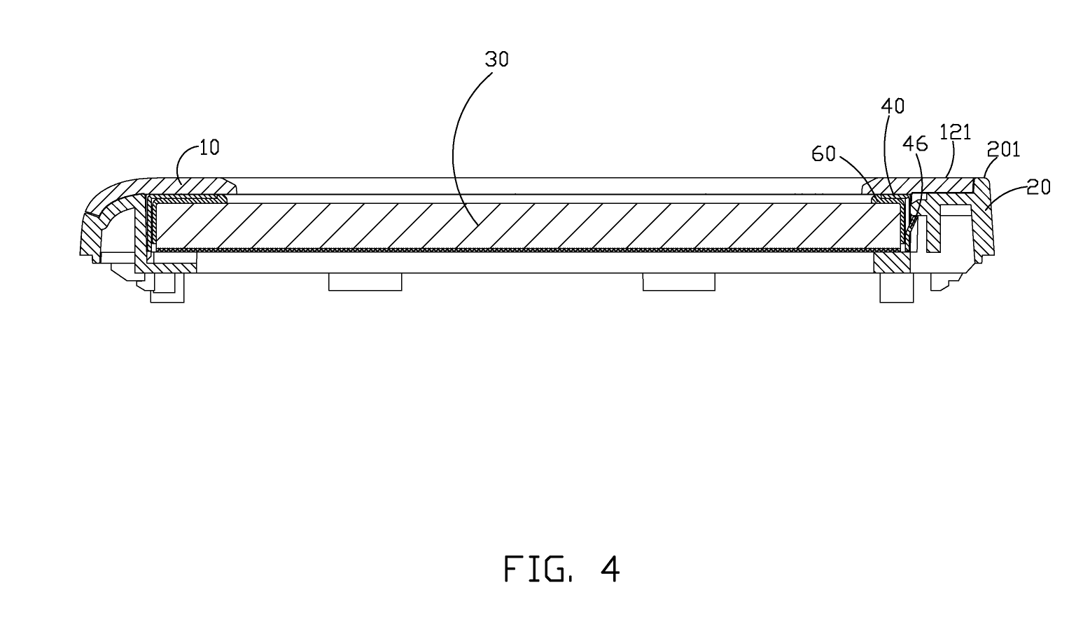

Referring to FIG. 4, the shielding frame 40 comprises plurality of latching portions 46 opposite to the plurality of latching grooves 26, respectively. In this embodiment, the latching portions 46 are integrally formed with the shielding frame 40. The shielding frame 40 covers the rubber frame 60 to improve the ability of the LCD module to resist pressure. The latching portions 46 of the shielding frame 40 engage with the plurality of latching groove 26 to fix the LCD module 30 in the housing 20.

The bezel 10 comprises a panel portion 12 and a plurality of retaining arms 18 perpendicular to the panel portion 12. The panel portion 12 covers the shielding frame 40. The plurality of retaining arms 18 are received in the plurality of receiving rooms 28 and engage with the shielding frame 40 respectively to secure the bezel 10 to the shielding frame 40. In this embodiment, each of the plurality of retaining arms 18 comprises a hook 181 configured on a free end of the retaining arm 18. The hooks 181 engage with an edge 401 opposite to the supporting shoulder 24 of the shielding frame 40 to secure the bezel 10 to the shielding frame 40. In other embodiments, the plurality of retaining arms 18 are adapted to have enough elasticity to cooperatively clamp the shielding frame 40 to secure the bezel 10 to the shielding frame 40.

The panel portion 12 comprises a first outer surface 121. The housing 20 comprises a second outer surface 201. The first outer surface 121 is substantially coplanar with the second outer surface 201 to provide a smooth appearance of the electronic device 100.

In this disclosure, the LCD module 30 is fixed in the housing 20 via the shielding frame 40 engaging with the frame portion 22 of the housing 20. The shielding frame 40 made of metal material, such as stainless steel, has high intensity and small thickness. The bezel 10 is used to cover the shielding frame 20 for decoration and need not be fabricated with enough intensity and thickness. Therefore, the electronic device 100 has a small size, and the LCD module 30 is secured in the housing 20 reliably.

In this embodiment, the electronic device 100 further comprises a cushion 80 disposed between the LCD module 30 and the supporting shoulder 24 to protect the LCD module 30 from shocks and vibrations.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An electronic device, comprising:
a housing, comprising a frame portion and a supporting shoulder extending inwardly from the frame portion, the frame portion defining a plurality of latching grooves and a plurality of receiving grooves;
a liquid crystal display (LCD) module, received in the housing and supported on the supporting shoulder;
a rubber frame, disposed between the housing and the LCD module to protect the LCD module;
a shielding frame, comprising a plurality of latching portions to engage with the plurality of latching grooves in the housing respectively to fix the LCD module in the housing, the shielding frame covering the rubber frame; and
a bezel, comprising a panel portion and a plurality of retaining arms perpendicularly extending from the panel portion, the panel portion covering the shielding frame, the plurality of retaining arms respectively received in the plurality of receiving grooves and engaged with the shielding frame to secure the bezel to the shielding frame.

2. The electronic device as claimed in claim 1, further comprising a cushion disposed between the LCD module and the supporting shoulder to protect the LCD module from shocks and vibrations.

3. The electronic device as claimed in claim 2, wherein the latching portions are integrally formed with the shielding frame.

4. The electronic device as claimed in claim 3, wherein each of the plurality of retaining arms comprises a hook configured on a free end of the retaining arm and engaging with an edge opposite to the supporting shoulder of the shielding frame to secure the bezel to the shielding frame.
